(19) United States
(12) Patent Application Publication
(10) Pub. No.: US 2010/0136971 A1
(43) Pub. Date: Jun. 3, 2010

(54) Usage of MSISDN in Subscription Assignment

(75) Inventors: Signe Marie Holter, Oslo (NO); Olav Afdal, Slependen (NO); Ola Smith, Stockholm (SE); Stefan Karisson, Bastionsgatan 4 (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON, STOCKHOLM (DE)

(21) Appl. No.: 12/598,829

(22) PCT Filed: May 4, 2007
(86) PCT No.: PCT/EP07/54371

§ 371 Date: Nov. 4, 2009

(51) Int. Cl. H04W 60/00

(52) U.S. Cl. 455/435.1

(57) ABSTRACT

The present invention relates to a method and device for activating a subscription in a cellular network comprising a register unit for a cellular network, said register unit storing at least one unique identity number which identifies a subscriber identity module. The stored identity number is registered in a cellular network subscription. The method is further characterized in the steps of: the register unit receiving the unique identity number for a subscriber identity module when the module is activated, and the register further assigning an authentication number with the received identity number—so that it defines the registered subscription.

### TECHNICAL FIELD

The present invention relates to a method and device for activating a subscription in a cellular network comprising a register unit for a cellular network, said register unit storing at least one unique identity number which identifies a subscriber identity module. The stored identity number is registered in a cellular network subscription.

### BACKGROUND

It have been more and more common during the last years with mobile phones. When buying these phones, the normal procedure is that you also accept a certain curing period for the subscription. Since these periods' ends, the number of phones available and operating, which allows the owner to choose subscriptions increases dramatically. Moreover, there is an increasing number of simple, cheap phones on the market and phones which was bought with a cash card. When summarizing these trends, it is clear that there is an increasing market for different kinds of subscriptions.

Since a subscription for a particular service provider is connected to the provisioning of a SIM-card, the number of SIM-cards available increases dramatically. These cards stored in retailers shelves, prepaid by the retailer, and handed over to the user when he/she buys a subscription. As mentioned, the subscription could for instance be the kind relating to a curing period or a cash card.

Each SIM-card contains an IMSI (International Mobile Subscriber Identity) which is a unique number. When the SIM is activated it sends the IMSI to the mobile network for identification. In CDMA, RUIMS-card is the equivalent. The first time SIM is activated, the IMSI needs to be defined in the AuC (Authentication Centre). It is a function to authenticate the SIM-card that attempts to connect to the network. If the authentication is accepted, the HLR (Home Location Register) or the VLR (Visitor Location Register) (will manage the SIM-card and generate an encryption key for the normal communication (to avoid eavesdroppers). If the authentication is not accepted, no communication between the SIM-card and the network is accepted.

The retailer keeps a number of SIM-cards from different operators on stock. Each SIM-card has a MSISDN (Mobile Station Integrated Services Digital Network). MSISDN is a number of digits that is used to refer to a particular mobile device. The assignment of the MSISDN number is done by the service provider before selling the cards to the retailer. The MSISDN number is stored in the network and is linked to the IMSI number of the card. When the card is activated, the mobile network of that operator will recognize that a subscription is related to the IMSI by checking the MSISDN. When recognized, the subscription is defined by connecting the related MSISDN to the IMSI and the subscribers profile in the HLR. After this, the subscriber services could be added or changed.

Following this registration, each time when the phone with the SIM is switched on, it will issue a location update IMSI attach message to the network. This message is received by the MSC (Mobile Switching Center), VLR, which (maybe via VLR) passes it to the HLR. The HLR will see if the IMSI is connected to a subscription (via MSISDN) and either accept or reject the phone/card. The HLR will if a VLR is involved for the first time, after the acknowledge send an insert subscriber data message with the subscriber data to the VLR.

The problem with the present assignment of MSISDN numbers in the network is that they are scarce. The MSISDN is allocated in the HLR before the card is being sold to the retailer. Thereafter, it may take months before it is activated for the first time be the user. This is a very inefficient use of a scarce resource since it is allocated but not used. This is especially a problem on markets where it is common with short life subscriptions, where there is a need of preinstalled subscriptions and where SIM-cards are needed urgently. Furthermore, the availability of the funds, connected to the subscription need to have a lifecycle that it separate from the SIM-card.

### SUMMARY

The object of the present invention is to solve the above mentioned problem by providing a method and device for reducing the use of scarce MSISDN.

The object is achieved by means of a register unit for a cellular network, said register unit being adapted for storing at least one unique identity number which identifies a subscriber identity module. The stored identity number is registered in a cellular network subscription. The register is further characterized in that it is adapted for receiving the unique identity number for a subscriber identity module when the module is activated and further adapted for assigning an authentication number with the received identity number so that it defines the registered subscription.

The object is also achieved by means of a subscriber identity module for communicating with the register unit for a cellular network, said module being adapted for storing a unique identity number which identifies the module. The stored identity number is registered in a cellular network subscription. The module is further characterized in that it is adapted for sending the unique identity number for the module to the register unit when the module is activated so that the register unit assigns (19) the authentication number (20) with the received (17) identity number (20).

The object is further achieved by means of a method for activating a subscription in a cellular network comprising a register unit for a cellular network, said register unit storing at least one unique identity number which identifies a subscriber identity module. The stored identity number is registered in a cellular network subscription. The method is further characterized in the steps of: the register receiving the unique identity number for a subscriber identity module when the module is activated, and the register is further assigning an authentication number with the received identity number so that it defines the registered subscription.

The object is finally achieved by means of a method for activating a subscription in a cellular network comprising a subscriber identity module communicating with a register unit for the cellular network, the module storing a unique identity number which identifies the module. The stored identity number is registered in a cellular network subscription. The method is further characterized in the steps of the module sending the unique identity number to the register unit when the module is activated for the assignment of (19) the authentication number (20) with the received (17) identity number (20).

One advantageous effect of the present invention of allocating a MSISDN to a subscription when the subscription is activated by the user is that it will allow an efficient use of scarce MSISDNs. This makes it possible for the service provider to distribute subscription starter packages to its retailers and customer companies that consumes a large number of subscriptions, such as telemetric solution providers that may store subscription packages or SIM cards on the shelf, without impacting the availability of MSISDN numbers in the network. In case the SIM is built into a telemetric unit this is a reason for not assigning an MSISDN.

Another advantageous effect relates to the combination with aggressive expiry rules of subscriptions, for instance the force activity on it or, maybe in the case of prepaid subscriptions, force frequent refills to the account used by the subscription. This combination will support short lived subscriptions. The operator can use the same MSISDN more often and hence the need for even more numbers of MSISDNs is slowing down.

Another advantage is that when the MSISDN is allocated at activation of the subscription, this provides the possibility of bulk subscriptions such as telemetric solutions in addition to short lived subscriptions.

Another advantage is that the exchange which will assign a phone number to the customer can offer as a first solution the first available number in an idle list and in a future perspective is can be possible for the exchange to have a functionality which offer the customer possibilities to choose the number to be assigned.

### BRIEF DESCRIPTION OF DRAWINGS

The present invention will now be described more in detail with reference to the appended drawings:

FIG. 1 schematically shows the register unit and the communication means for enabling the method of activating a subscription.

FIG. 2 schematically shows the register unit and the communication means for communication data in relation to the activated subscription.

FIG. 3 shows the method of activating the subscription according to FIG. 1.

FIG. 4 shows the method according to FIGS. 1-3 more in detail.

FIG. 5 shows the communication of data according to FIGS. 1-3.

### DETAILED DESCRIPTION

The register unit, the subscriber identity module and the method for activating a subscription in a cellular network will now be described with reference to an embodiment.

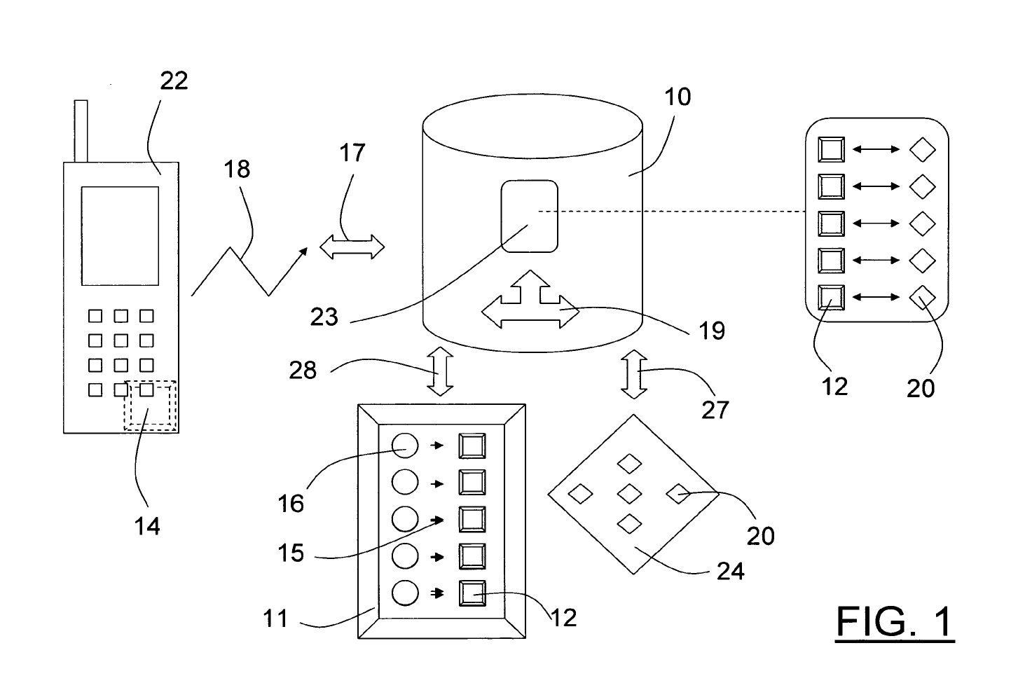

The register unit 10, see FIG. 1, for a cellular network according to the present invention is adapted for storing 11 at least one unique identity number 12 which identifies a subscriber identity module 13, said stored identity number being registered 15 in a cellular network subscription 16. The register unit preferably comprises a HLR (Home Location Register) and an AuC (Authentication Centre). The identity number preferably consists in a IMSI (International Mobile Subscriber Identity) which is the unique identity number for a particular subscriber identity module. The IMSI is stored in the HLR and AuC, possibly in a specific number range that applies for a special treatment.

The subscriber identity module which communicates with the register unit is adapted for storing the unique identity number which identifies the module, said stored identity number being registered in a cellular network subscription.

What particularly characterizes the present invention is that the register unit 10 is adapted for receiving 17 the unique identity number 12 for a subscriber identity module (SIM) 14 when the subscriber identity module is activated 18. The register is further adapted for assigning 19 an authentication number 20 with the received identity number so that it defines 21 the registered subscription 16. The authentication number preferably consists in a Mobile Station International ISDN (MSISDN). Since the subscriber identity module 14 cooperates with the register unit it is adapted for sending 17 the unique identity number 12 for the module to the register unit when the module is activated 18 for the assignment of (19) the authentication number (20) with the received (17) identity number (20).

When the SIM 14 is produced, including the necessary information for enabling the communication 17 with the register unit, it will be put into a package. These packages are produced in a large bulk or have a low turnover.

The advantageous effect is that it will allow an efficient use of scarce authentication numbers 20. This makes it possible for the service provider to distribute subscription starter packages (with the SIM) to its retailers and customer companies that consumes a large number of subscriptions 16, such as telemetric solution providers that may store subscription packages or SIM cards on the shelf, without impacting the availability of authentication numbers in the network.

When the SIM is produced, the subscription 16 is not fully provisioned in the register unit 10, and the authentication numbers 20 are not tied up by connecting it to an identity number/subscription 12/16. When the SIM 14 is activated for the first time, the register unit 10 will start the provisioning and assignment 19 of the authentication number 20 to the identity number and store 23 these assignments. This is an on-demand assignment of authentication number, which is the core of the present invention. The authentication numbers are stored in a number unit 24 that could be a pool in the register unit or a separate database. When assigning the authentication number with the identity number a profile applicable for this type of subscription is also assigned. Possibly, the register unit could also assign or change other subscriber data is needed.

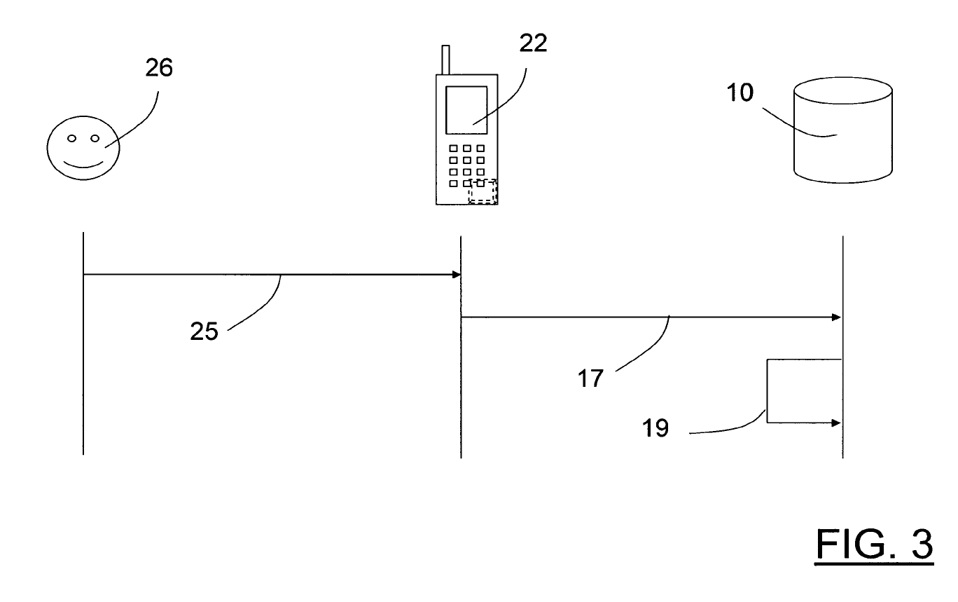

When the phone 22 is turned on 25 by the user 26, see FIGS. 1, 3 and 4, the SIM 14 is activated and sends 17 the unique identity number 12 to the register unit 10. This sending is preferably a location update request. The register unit preferably contains or communicates with a MSC (Mobile Switching Centre) and VLR (Visitor Location Register) 35 which then receives the sent 17 number, preferably in the form of the location update request. The MSC/VLR then sends 36 the identity number to the register unit for assignment. When the register unit 10, sees 26 that the identity number 12 received is up for a special treatment (assignment) 19, since there is no subscription 16 connected to it, the register unit will collect 28 an authentication number 20 from the number unit 24 where it is stored.

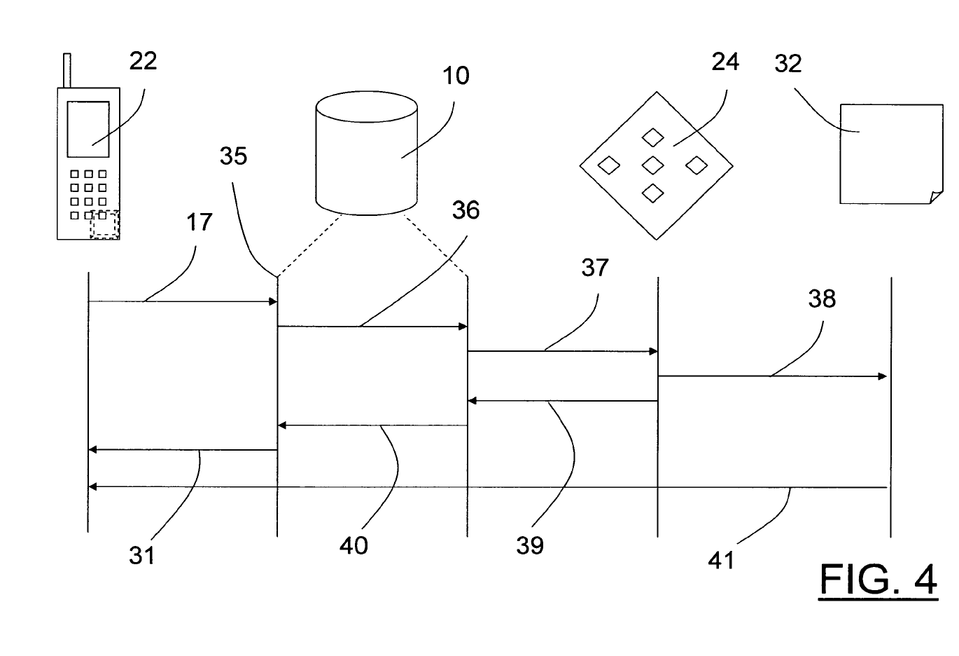

The collection of the authentication number consists in an operation based on a protocol for communication, see FIG. 4. The collection of the authentication number comprises the steps of the register unit sending data 37 containing instructions to return the authentication number to the register unit and the register unit receiving the authentication number. This operation, for instance named GET_MSISDN, is a new protocol according to the present invention. The data 37 is sent to the number unit 24 containing the authentication numbers 20.

A successful collection in the number unit 24 could preferably generate an external signal 38 to an SMS S-C (Switching Centre) 32 to issue an SMS 41 as an indication with information about the subscription. Such information is for instance the authentication number and information about the subscription. The user and/or phone are thereby highlighted about the activated subscriptions and its conditions. The indication may also be sent to an associated receiver (by SMS, online/offline, by email or other carrier) which could be a tracking server of a telemetric company that needs to keep track of the authentication numbers 20, the identity numbers 12 and the location of their equipment.

When the register unit receives 39 an authentication number 20 from the number unit 24, it then assigns 19 the authentication number with the received identity number 12 so that it defines the registered subscription 16. The register unit 10 will contain functionality which will recognize the type of SIM card 14. The authentication number is further adapted for assigning to the identity number in order to activate the registered subscription which means that it as available for said assignment.

When the assignment is made the register unit also sends 34 the same kind of indication 31 containing information about the registered subscription 16. For instance, the MSC/VLR receives 40 the subscriber information and then sends the indication but it may also be that the register unit triggers other kind of system parts to send such indications. The indication for instance comprises a voice announcement and be sent by SMS, USSD, data files, email or EDI. The indication may also contain IN (Intelligent Network) or CAMEL (Customized Application for Mobile Enhanced Logic) data. The register unit 10 preferably also generates an external signal 38 to an SMS S-C (Switching Centre) 32 to issue an SMS 41 as an indication with information about the subscription. The indication may also here be sent to such an associated receiver (by SMS, online/offline, by email or other carrier).

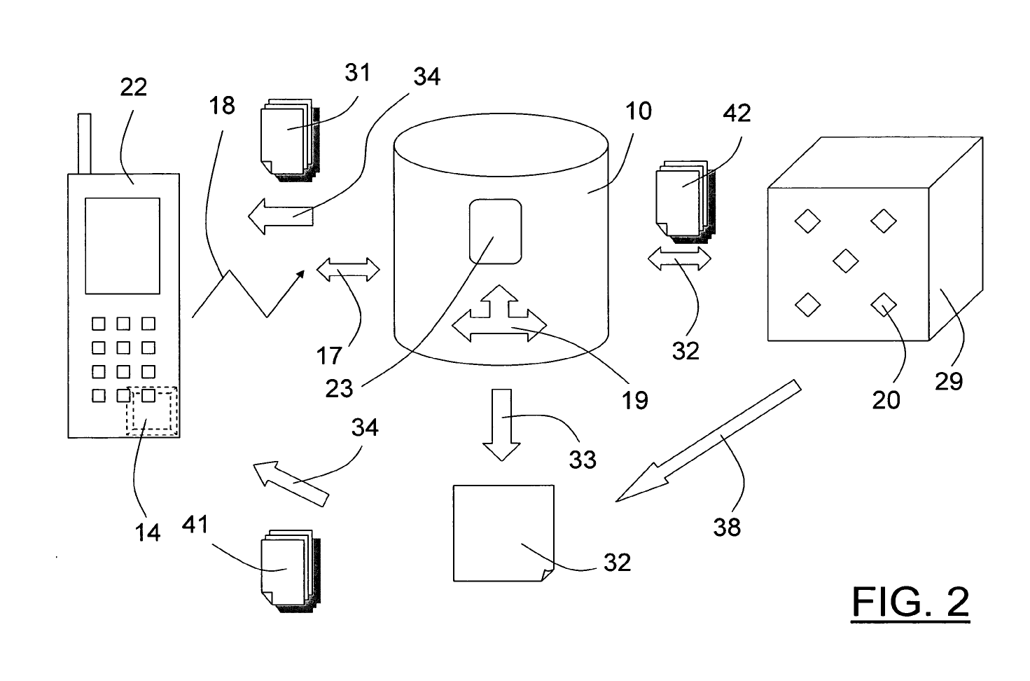

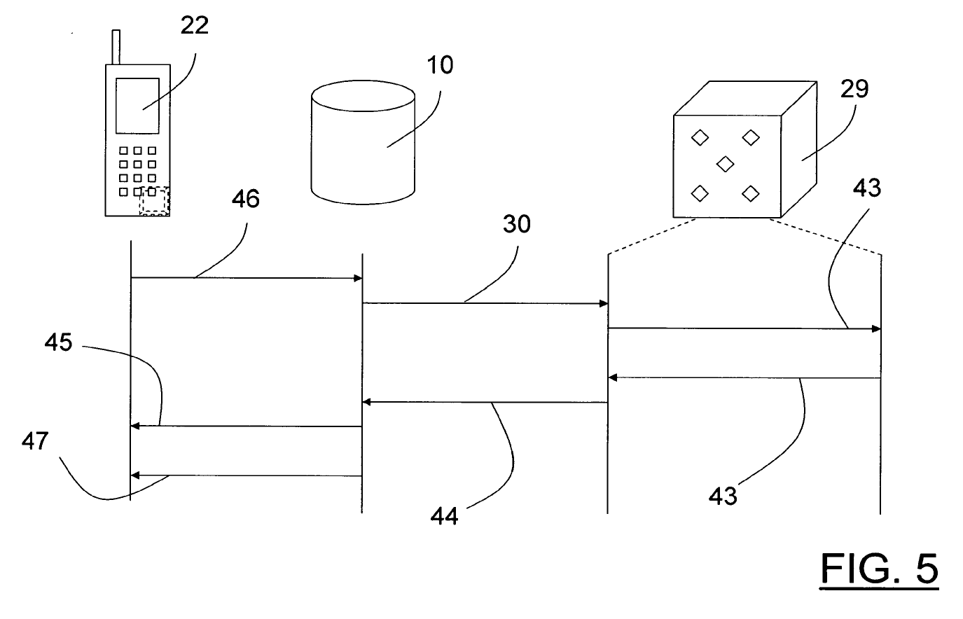

The subscription 16 is for instance a prepaid or postpaid subscription. There are a number of ways of how to fulfil the subscription when the SIM is activated and these are examples of how this could be accomplished. A prepaid subscription has an amount allocated for calling etc while in postpaid the user 26 pays afterwards. In such subscriptions, the authentication number 20, an maybe also the identity number 12, is preinstalled in a prepaid or charging system 29, see FIGS. 2 and 5. The system preferably comprises a SCP (IN Service Control Point) and a SDP (Service Data Point). The register unit 10 sends and/or receives 30 trigger or order signals 42 for activating at least one activity in the register unit 10 or the prepaid or charging system 29. Such a trigger preferably contains IN/CAMEL data and is initiated by the first call 46 in the mobile phone 22. Such an activity for instance consists in the system requesting and/or the register unit sending 45 an indication 31 (such as an SMS) and/or removing data.

When the first call 46 is made, the prepaid or charging system 29 receives trigger or order signals 30 from the register unit 10, the system activities comprises the steps of requesting and receiving 43 data about the subscription 16, if it is the first time the subscription is in use sending a trigger signal 44 to the register unit, and the register unit sending an indication 31 containing information about the registered subscription 16.

The trigger signal is preferably sent to the SCP as part of the prepaid system 29 (made with IN/CAMEL protocol). The SCP sends 43 the request for data relating to this subscription to the SDP, which is also part of the prepaid system and which holds account data. This is done with any suitable protocol that is present. The data returned 43 to the SCP indicates that this is the first time the subscription is used and that an trigger 44 should be sent to the register unit 10, preferably the SSF (Service Switching Function) as part of the register unit together with the MSC/VLR, ordering the unit to send 45 the indication 31. In this case, the indication is preferably in the form of a voice announcement sent to the mobile phone 22 which states the options of the subscription activated by the phone call (or any other communication session by the phone). After the announcement/indication is made the call continues as normal 47.

The prepaid system will treat the call as a first call and generate an indication as a welcome announcement. In a postpaid system that is registered in an off-line billing system, an IN protocol could be used temporarily to get this announcement for the postpaid subscription in the following way:
A welcome service in SCP (which is not part of a postpaid system) exits.
At first use the register unit (HLR) assigns the authentication number 20 (MSISDN) and additionally sets IN/CAMEL trigger information in order for the first user activity to trigger the welcome service in SCP.
At first use the service is triggered and routes the call to an announcement machine welcoming the user and announce the authentication number (MSISDN) and then allows the call to be setup and then removes all IN/CAMEL data set for the user in HLR. If the user activity was a SMS or other event not being a call an SMS, MMS, USSD could be sent to the user.

Another activity is the trigger of data to be removed. Such data is trigger data stored in the register unit 10 when receiving the order to activate the announcement. Such trigger data is removed be a special IN/CAMEL trigger either directly via an online protocol or via any external system that acts on logged data from the IN/CAMEL service.

The possibilities of the user interaction provided by the IN or CAMEL service are big. As an example the service could be set to play a number of announcements and repeat announcements a number of times when the call is made. If the service is to provide more announcements than the initial, the activity removing the trigger data should not be made.

The solution opens also up for that that the subscriber could be postpaid. This subscriber could be controlled by the prepaid or charging system but it could also be handled with temporary triggering data for an IN solution that plays the indication announcement and then removes the triggering conditions.

In any of these cases, the method is based on dynamic assignment of authentication numbers. When the number has been assigned it is still possible to change the authentication number if wanted by the operator.

A IN/CAMEL service or service node could preferably have an assigned number to which the user could call. A user prompt guides the user and the menu could be “get 5 new suggested MSISDN” that announce 5 unassigned numbers from HLR. After the announcement the user could select a new number or ask for more suggestions. The system updates the subscription with the new number according to standard procedures. The same could be done using USSD and similar user interactions could be done with SMS or MMS. The receiver returns some new numbers that gets temporary blocked in the HLR (so that no one else could select them). The user could then send a new SMS with the selected number that is allocated and the other temporary blocked numbers are de-allocated. Subscription is then updated. Customer care could do the change manually.

1. A register unit for a cellular network, said register unit being adapted for storing at least one unique identity number which identifies a subscriber identity module, said stored identity number being registered in a cellular network subscription,
wherein that the register unit is adapted for receiving the unique identity number for a subscriber identity module when the module is activated for the first time wherein the module is activated by a phone, the register unit is further adapted for assigning an authentication number with the received identity number so that it defines the registered subscription and wherein said register unit further adapted for communicating said assigned authentication number to said phone.

2. The register unit according to claim 1 wherein the identity number consists in an international mobile subscriber identity.

3. The register unit according to claim 1 wherein the authentication number consists in a mobile station international ISDN.

4. (canceled)

5. The register unit according to claim 1 wherein the authentication number is adapted for assigning to the identity number in order to activate the registered subscription.

6. (canceled)

7. (canceled)

8. The register unit according to claim 1 wherein the cellular network subscription consist in a prepaid or postpaid subscription.

9. (canceled)

10. The register unit according to claim 8 wherein the register unit is adapted for sending and/or receiving trigger or order signals for activating at least one activity in the register unit or the prepaid or charging system.

11. (canceled)

12. (canceled)

13. The register unit according to claim 1 wherein the communication is sent by SMS, USSD, data files, email or EDI.

14. (canceled)

15. (canceled)

16. (canceled)

17. (canceled)

18. A method for activating a subscription in a cellular network including a register unit for a cellular network, said register unit storing at least one unique identity number which identifies a subscriber identity module, said stored identity number being registered in a cellular network subscription, comprised by the steps of:
the register unit receiving the unique identity number for a subscriber identity module when the module is activated for the first time wherein the module is activated by a phone,
the register unit assigning an authentication number with the received identity number so that it defines the registered subscription; and
the register unit communicating said assigned authentication number identifying said register subscription to said activating phone.

19. The method according to claim 18 wherein said unique identity number is an international mobile subscriber identity (IMSI) number uniquely identifying said subscriber identity module (SIM) associated with said activating phone.

20. The method according to claim 19 wherein said authentication number is a mobile station international ISDN (MSISDN) number for uniquely identifying said register subscription.

21. (canceled)

22. (canceled)

23. The method according to claim 18 wherein the register unit or a prepaid or charging system sends and/or receives trigger or order signals for activating at least one activity in the register unit or the prepaid or charging system.

24. The method according to claim 23 wherein the activities comprises the steps of:
the prepaid or charging system requesting and receiving data about the subscription, and
if it is the first time the subscription is in use sending the trigger signal to the register unit, and
the register unit sending an indication containing information about the registered subscription.

25. (canceled)

26. (canceled)

27. A method for assigning an identity number uniquely identifying a subscriber identity module with an authentication number uniquely identifying a particular subscriber subscription, said method comprising the steps of:
receiving an identity number associated with a subscriber identity module (SIM) from a mobile station;
determining that said subscriber identity module (SIM) is being activated for the first time;
assigning an authentication number uniquely identifying a particular subscriber subscription to said SIM;
communicating said assigned authentication number to said mobile station.

28. The method of claim 27 wherein said identity number is an international mobile subscriber identity (IMSI).

29. The method of claim 27 wherein said authentication number is a mobile station international ISDN (MSISDN) number.

30. The method of claim 27 wherein said subscriber subscription includes a prepaid or postpaid subscription.

31. The method of claim 27 wherein said step of communicating comprises sending an SMS, USSD, data files, emails or EDI to said mobile station identifying said authentication number.

32. The method of claim 27 wherein further comprising the steps of:
communicating more than one authentication numbers to said mobile station allowing said mobile station to select one from said communicated authentication numbers; and
assigning said selected authentication number with said SIM.

33. The register unit of claim 1 further adapted to communicate more than one authentication numbers to said phone allowing said phone to select one from said communicated authentication numbers and further adapted for assigning said selected authentication number with the received identity number.

34. The method of claim 18 further comprising the steps of communicating more than one authentication numbers to said activating phone allowing said phone to select one from said communicated authentication numbers and assigning said selected authentication number to said received identity number.
